(19) United States
(12) Patent Application Publication
(10) Pub. No.: US 2003/0094199 A1
(43) Pub. Date: May 22, 2003

(54) System and method for pumping high-viscous fluids through heat exchangers

(75) Inventor: Markus Roediger, Sewickley, PA (US)

Correspondence Address: Ansel M. Schwartz, Suite 304, 201 N. Craig Street, Pittsburgh, PA, 15213, US

(73) Assignee: Roediger Pittsburgh, Inc.

(21) Appl. No.: 09/992,695

(22) Filed: Nov. 20, 2001

(51) Int. Cl. F16L 53/00; F16K 49/00

(52) U.S. Cl. 137/334

(57) ABSTRACT

A system for pumping a fluid having a viscosity at least five times water's viscosity through at least one heat exchanger. The system includes a positive displacement pump, pumping the fluid through the heat exchanger. The system includes a booster pump that is installed downstream of the heat exchanger. A method for pumping high-viscous fluid through a heat exchanger. The method includes the steps of pumping the high-viscous fluid with a variable speed positive displacement pump. There is the step of driving the fluid through a heat exchanger. There is the step of forwarding the fluid through a booster pump.

### FIELD OF THE INVENTION

The present invention relates to a system for pumping a high-viscous fluid, such as sewage sludge or wastewater sludge, through a heat exchanger.

### BACKGROUND OF THE INVENTION

The head loss of a laminar flow is substantially proportional to the fluid's viscosity, the shear rate (=velocity gradient) at the pipe or channel wall (which in turn is proportional to the flow velocity divided by the hydraulic diameter) and the length of the pipe or channel. The head loss is inversely proportional to the hydraulic diameter of the pipe or channel. If the fluid has a high viscosity, the Reynolds number of the fluid flow is low and the flow is therewith usually laminar. The hydraulic diameter of a flow through a heat exchanger should be small in order to increase the heat exchanger surface within a given heat exchanger volume. This also decreases the Reynolds number.

An example will demonstrate these relationships: A Newton-type fluid with a specific mass ρ=1000 kg/m³ and a viscosity η=0.05 kg/(m*s) is pumped with a mean velocity v=1 m/s through a heat exchanger. The heat exchanger has a channel length l=50 m and a hydraulic channel diameter d=0.02 m. The Reynolds number of the flow through the channel is Re=v*d*ρ/η=400. This is a laminar flow (Re<<2320).

The shear rate at the channel wall is dv/ds=8*v/d=400 s⁻¹ for a Newton-type fluid and laminar flow. The head loss of the flow of a Newton-type fluid through the heat exchanger is Δp=4*dv/ds*η*l/d=200,000 kg/(m*s²)=200,000 N/m²=2 bar.

An example of a high-viscous fluid is raw sewage sludge that has a solids concentration above 3%, particularly if the sewage sludge contains a high proportion of high-viscous secondary sludge, e.g. waste activated sludge.

It should be noted that many high-viscous fluids, e.g. sewage sludge, are non-Newton type fluids. While a Newton-type fluid has a viscosity η that is independent of the shear rate dv/ds, the viscosity η of a non-Newton type fluid changes with the shear rate dv/ds. Some high viscous fluids, such as sewage sludge, also show a certain minimum shear force and therewith an unlimited viscosity η at a shear rate of zero. Head loss calculations for such non-Newton type fluids are far more complex than those for a Newton-type fluid. For the purpose of explaining the present invention, however, it is sufficient to use a simple Newton-type fluid as an example.

A positive displacement pump (e.g. a progressive cavity pump as manufactured by Moyno Pumps, Inc.) can easily generate a discharge pressure far exceeding the head loss through the heat exchanger. Positive displacement pumps are typically used for pumping high-viscous fluids through heat exchangers because their flow remains almost independent of their discharge pressure. Their flow is approximately proportional to the pump speed and therefor controlled by variation of the pump speed.

Heat exchangers are preferably built of thin wall heat exchange plates or pipes in order to reduce the heat transfer resistance through their wall. Thin wall heat exchangers, however, cannot sustain high fluid pressures without being damaged. This is particularly the case for spiral heat exchangers (as manufactured e.g. by Gooch, Inc.), especially if they are built for transferring heat from one sludge flow to another sludge flow. The channels in the heat exchanger must not be obstructed by studs or other reinforcing elements because such elements could result in clogging of the flow path by particles, hair, rags or other debris that may be present in sewage sludge.

Common spiral heat exchangers for sludge to sludge heat transfer are designed for a maximum operational pressure of about 4 bar (carbon steel) or 3.5 bar (stainless steel).

Sometimes the high-viscous fluid is pumped not only through a single heat exchanger, but thereafter through another heat exchanger, and/or into a vessel with a high head. In such cases, the pressure at the entrance of the first heat exchanger would be the sum of the head losses of all heat exchangers and of the head of the vessel. The vessel could be for example a high digester or pasteurization tank with a high hydrostatic head.

FIG. 1 shows an example of a sludge pasteurization system where two spiral heat exchangers are installed. The fluid of the example is pumped by a positive displacement pump (10) through a first sludge/sludge heat exchanger (12). The fluid is preheated during its passage through the first heat exchanger while hot pasteurized sludge is simultaneously cooled in another channel of this sludge/sludge heat exchanger. The preheated fluid is then forwarded through a second sludge/water heat exchanger (14) wherein it is heated by hot water to its pasteurization temperature of e.g. 70° C. We assume that the second heat exchanger has the same head loss of 2 bar as the first one. After passage of the second heat exchanger the sludge is pressed into a vessel (16) with a liquid level of 10 m above the heat exchangers. The pressure at the entrance of the (first) heat exchanger (12) would be the sum of 1 bar (hydrostatic head)+2 bar (second heat exchanger)+2 bar (first heat exchanger)=5 bar. This would be too high for a common spiral heat exchanger.

The pasteurized sludge in the example of FIG. 1 is pumped by a second positive displacement pump (18) from the pasteurization vessel (16) through the other channel of the first sludge/sludge heat exchanger (12) into a 30 m high digester (20). The pressure of the cooled pasteurized sludge at the exit of the first heat exchanger (12) is the hydrostatic head of the digester (=3 bar). The head loss of the pasteurized sludge through the heat exchanger (12) is assumed to be also 2 bar. The pressure of the pasteurized sludge at the entrance into the first heat exchanger (12) is 3+2=5 bar. This is again too high for a conventional spiral heat exchanger.

The first heat exchanger (12) could be built of thick wall plates or pipes to withstand high pressure, but its costs would increase and its heat transfer capacity would be reduced. Especially if the heat exchanger is built of expensive stainless steel with a relatively low strength and heat conductivity, compared to carbon steel, increasing the wall thickness would not be a good strategy. With increased wall thickness, the heat transfer area of the heat exchanger, i.e. the length of the flow pass, would also have to be increased and consequently the head loss would rise even further.

It is state of the art to install another positive displacement pump at the downstream side of the heat exchanger to reduce the pressure in the heat exchanger. FIG. 2 illustrates this option.

All pumps in FIG. 2 are positive displacement pumps. A positive displacement pump is a pump with a flow that is proportional to the pump speed, but almost independent of the pump head.

A third positive displacement pump (30) is installed downstream of the cold sludge side of heat exchanger 12 and a fourth positive displacement pump (32) is installed downstream of the hot sludge side of heat exchanger 12. It would be virtually impossible to control the pressure at the inflow of a downstream positive displacement pump if the upstream positive displacement pump would feed directly into the downstream pump. If the speed of the upstream pump would be only slightly higher than the speed of the downstream pump, a very high pressure would be generated at the inflow connection of the downstream pump and the heat exchanger in between the pumps and the upstream pump would be destroyed. If the speed of the upstream pump would be only slightly lower than the speed of the downstream pump, a vacuum would be generated at the inflow connection of the downstream pump and at least at the exit connection of the heat exchanger in between. Such a vacuum could also destroy the heat exchanger and the downstream pump. To prevent damage to the positive displacement pumps and the heat exchanger in between, intermediate vessels (34,36) with level or pressure sensors are required to control the speed of the downstream pumps (30,32). The speed of the downstream pumps (30,32) is increased if the level in open vessels (34,36) rises, or if the pressure in the headspace of closed vessels (34,36) rises. The speed of the downstream pumps (30,32) is decreased if the level or headspace pressure of the vessels (34,36) drops. Disadvantages of this state of the art system are that positive displacement pumps are expensive and require a large space, that extra intermediate vessels (34,36) for the compensation of flow variation, level or pressure sensors, controllers and variable frequency drives for the downstream pumps (30,32) are required. In other words, this is an expensive and complicated solution.

The problem of the present invention is to provide a system for pumping a high viscous fluid through a heat exchanger whereby the pressure at the entrance of the heat exchanger is kept lower than the design pressure of the heat exchanger to prevent the danger of heat exchanger damaging. This system should be simple and inexpensive.

### SUMMARY OF THE INVENTION

The present invention pertains to a system for pumping a fluid having a viscosity at least three times water's viscosity through at least one heat exchanger. The system comprises a positive displacement pump, pumping the fluid through the heat exchanger. The system also comprises a booster pump that is installed downstream of the heat exchanger.

The present invention also pertains to a method for pumping sewage sludge through a heat exchanger. The method comprises the steps of pumping a high-viscous fluid with a variable speed positive displacement pump. There is the step of driving the fluid through a heat exchanger and the step of forwarding the fluid through a booster pump.

The problem is solved according to the present invention by installation of a booster pump on the downstream side of the heat exchanger, whereby the speed of the booster pump does not need to be controlled to match the flow of the positive displacement pump. Such a booster pump is preferably a simple centrifugal pump. The pressure difference between the discharge and inflow connections depends on the pump speed and its pump curve. Centrifugal pumps have a pump curve with a maximum head at no flow and an initially gradually and then steeper and steeper dropping head as the flow increases, and with a maximum flow at zero head. The booster pump used for the purpose of the present invention should have such a pump curve that the head is relatively flat at its duty point, i.e. the maximum flow of the booster pump should far exceed the maximum flow of the feeding positive displacement pump. If this is the case, the head of the booster pump is almost independent of the fluid flow.

It is not obvious to place a booster pump downstream of the heat exchanger because it is generally believed that a booster pump would be too far off its normal duty point thus resulting in pump cavitation. However, the present invention recognizes that cavitation does not occur if the booster pump is selected such that Is it cannot pull a strong vacuum. Another indication for the inventiveness of the present invention is that prior art uses a second positive displacement pump (as shown in FIG. 2) in spite of the fact that installation of a downstream positive displacement pump is expensive and complicated because an intermediate vessel, a sensor and speed control of the downstream pump is necessary.

Preferably, the booster pump is provided with a by-pass, and this by-pass as well as the suction and pressure connections of the booster pumps are provided with check valves. This permits shutting off and by-passing the booster pump while the viscosity of the fluid and therewith the head loss through the heat exchanger is low. While the booster pump is shut off, the positive displacement pump presses the sludge through the by-pass connection and its check valve. This check valve prevents re-circulation flow while the booster pump is on. The check valves in the suction and pressure connections of the booster pump prevent particular matter in the fluid from entering the booster pump while it is shut off.

Preferably, the check valve in the suction connection has a closing pressure at no-flow condition exceeding the head loss through the check valve in the by-pass connection at maximum flow. In this way, it is prevented that a portion of the flow is pressed through the booster pump while it is shut off. In a preferred embodiment, the check valve in the suction connection of the booster pump has a lever and weight, whereby the lever is about horizontal while the check valve is closed, thus exerting a strong closing momentum. The lever is almost vertical while this check valve is fully open, thus creating a low closing momentum and head loss while the booster pump is on.

### BRIEF DESCRIPTION OF THE DRAWINGS

In the accompanying drawings, the preferred embodiment of the invention and preferred methods of practicing the invention are illustrated in which:

FIG. 1 is a schematic representation of a prior art sludge pasteurization system as an example for the pumping of a high-viscous fluid through heat exchangers.

FIG. 2 is a schematic representation of the prior art sludge pasteurization system according to FIG. 1 with the difference that positive displacement pumps are installed downstream of heat exchangers.

FIG. 3 is a schematic representation of a sludge pasteurization system of the present invention as an example where booster pumps are installed downstream of heat exchangers.

FIG. 4 is a schematic drawing of a booster pump that is provided with a by-pass connection and check valves.

### DETAILED DESCRIPTION

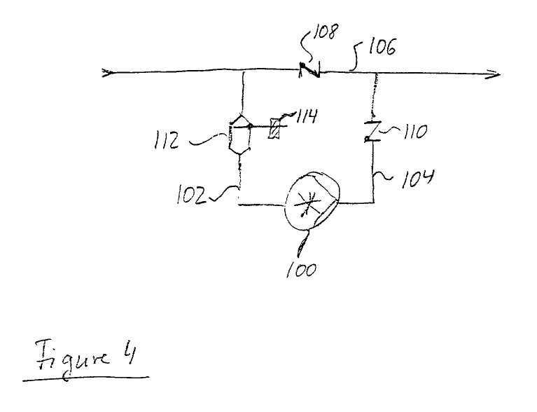

Referring now to the drawings wherein like reference numerals refer to similar or identical parts throughout the several views, and more specifically to FIG. 3 thereof, there is shown a system for pumping a fluid, having an apparent viscosity of at least five times water's viscosity, through at least one heat exchanger. The system comprises a positive displacement pump, pumping the fluid through the heat exchanger. The system comprises a booster pump that is installed downstream of the heat exchanger.

The booster pump forwards the fluid through a second heat exchanger and/or into a tank with a high head. A high head should be understood as a hydrostatic head of several meters water column. A booster pump is a pump that is installed downstream of another pump and that serves for creating additional pump head.

Preferably, the positive displacement pump is provided with a variable speed drive for fluid flow control. The booster pump can be operated with constant speed. However, the booster pump can also be provided with a variable speed drive for pump head control. The booster pump is typically a centrifugal pump. It can be a recessed impeller or vortex pump. The booster pump has a maximum pumping capacity exceeding the maximum flow through the positive displacement pump and should have a substantially flat pump curve at the maximum flow through the positive displacement pump so that the pump head of the booster pump is almost independent of the flow rate.

Whether the booster pump generates mainly or only a discharge pressure, or also some suction, depends on the specific circumstances, e.g. whether it forwards the sludge through another heat exchanger or into a high head tank.

FIG. 3 illustrates the present invention. It is assumed that booster pumps (40,42) with a head of 2 bars, independent of the flow, are employed. The discharge pressure of the first booster pump (40), installed downstream of the cold fluid side of the first heat exchanger (12), is the head loss of the second heat exchanger (14) (=2 bar) plus the head (=1 bar) of the pasteurization vessel (16). The discharge pressure of the booster pump (40) is therefore 1+2=3 bar. This is at the same time the pressure at the entrance into the second heat exchanger (14), which is lower than the design pressure of a conventional spiral heat exchanger.

The pressure on the suction side, or in this case better called inflow connection, of the booster pump (40) is its discharge pressure (=3 bar) minus its pump head (=2 bar). The inflow pressure is 3−2=1 bar. In this example the booster pump (40) does not generate any suction.

It is usually not necessary to control the speed of the booster pump because the flow through the booster pump is exactly the same as the flow generated by the positive displacement pump and controlled by its speed. However, if it is desired to control the head generated by the booster pump, a variable speed drive could be provided for the booster pump. The head of the booster pump is approximately proportional to the square of the pump speed. An increase of the pump's speed would not change the flow, but only the head.

In typical applications of centrifugal pumps the flow to the pump should not be restricted below a certain minimum to prevent pump cavitation. However, when a centrifugal pump is employed as the booster pump according to the present invention, cavitation does not occur unless the suction head of the pump would exceed a certain maximum of e.g. 0.7 bar. By proper selection of the booster pump this can always be prevented in our case. The maximum head of the booster pump should not exceed its minimum discharge pressure plus 0.7 bar.

The pressure at the entrance of the cold fluid into the first heat exchanger (12) is the inflow pressure of the booster pump (40) (=1 bar) plus the head loss through the first heat exchanger (12) (=2 bar). The pressure at the entrance of the first heat exchanger (12) is 1+2=3 bar. This is also lower than the design pressure of a conventional spiral heat exchanger.

The discharge pressure of the second booster pump (42) is the head of the digester (20) (=3 bar). The pump head is again assumed to be 2 bar. The pressure at the inflow of the booster pump (42) is 3−2=1 bar. The pressure at the entrance of the pasteurized sludge into the first heat exchanger (12) is 1+2=3 bar.

By the installation of the booster pump, the maximum pressure in the exemplary pasteurization system is reduced from 5 bar to 3 bar.

The booster pump can not only be a recessed impeller or vortex pump, it can also be a multi-vane centrifugal pump. Another option is use of a half-positive displacement pump (such as manufactured by Wemco-Hidrostal) that can generate high head at low flow. Selection of the pump also depends on characteristics of the fluid, e.g. the maximum particle size in sewage sludge and therewith the required clear passage of the pump, or on the presence of fibrous material in the fluid.

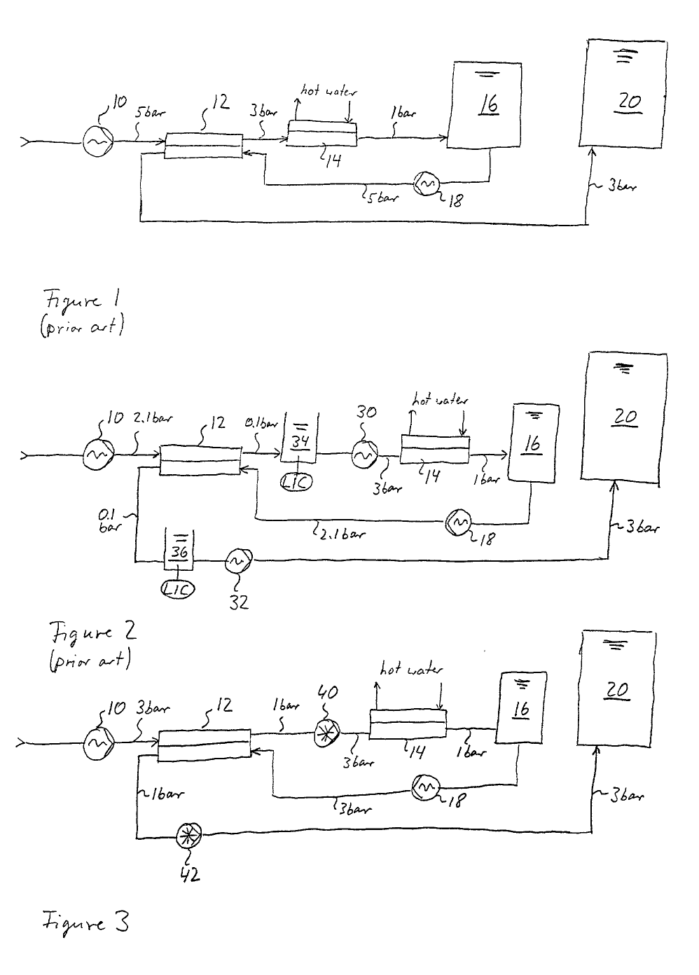

A booster pump is the second pump of two serial pumps. A second positive displacement pump as shown in FIG. 2 would not be a booster pump. A booster pump is a pump with a pump head that is almost independent of the flow. A positive displacement pump is a pump with a flow that is (almost, at least in theory) proportional to its speed and independent of the pressure difference. In other words: A booster pump has a flat pump curve, while a positive displacement pump has a very steep pump curve.

A half-positive displacement pump, however, has a characteristic between a positive displacement pump and a centrifugal pump and could be used as a booster pump.

FIG. 4 shows a booster pump (100) with a suction connection (102), a pressure connection (104) and a by-pass connection (106). A first check valve (108), e.g. as manufactured by Red Valve, is installed in the by-pass connection (106). This first check valve (108) prevents re-circulation of sludge through the booster pump (100) while it is on. A second check valve (110) is installed in the pressure connection (104). This second check valve (110) prevents particles from entering the booster pump (100) through its pressure connection (104) while the pump is off. A third check valve (112) is installed in the suction connection (120). This third check valve (112) prevents fluid from flowing through the booster pump while it is off. This third check valve (112) has a lever and weight (114) that are about horizontal while the check valve is closed so that a maximum closing momentum is generated by the weight. The closing pressure generated by this closing momentum should exceed the head loss of the first check valve (108) at maximum flow so that the third check valve (112) remains closed while the booster pump (100) is off. The lever and weight (114) are almost vertical when the third check valve (112) is fully open thus generating a low closing momentum and head loss through the check valve (112) when it is open while the booster pump (100) is on.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

What is claimed is:

1. A system for pumping a fluid having a viscosity at least five times water's viscosity through at least one heat exchanger, the system comprising:
a positive displacement pump, pumping the fluid through the heat exchanger; and
a booster pump that is installed downstream of the heat exchanger.

2. A system as described in claim 1 whereby a second heat exchanger is installed downstream of the booster pump so that the booster pump forwards the fluid through the second heat exchanger.

3. A system as described in claim 1, whereby the booster pump forwards the fluid into a vessel with a head of a minimum of 2 meters of water column.

4. A system as described in claim 1, whereby the positive displacement pump is provided with a variable speed drive for fluid flow control.

5. A system as described in claim 1, whereby the booster pump is operated with constant speed.

6. A system as described in claim 1, whereby the booster pump is provided with a variable speed drive for pump head control.

7. A system as described in claim 1, whereby the booster pump is a centrifugal pump.

8. A system as described in claim 7, whereby the booster pump is a recessed impeller or vortex pump.

9. A system as described in claim 1, whereby the booster pump is a half-positive displacement pump.

10. A system as described in claim 1, whereby the booster pump has a maximum pumping capacity exceeding the maximum flow through the positive displacement pump and a substantially flat pump curve at the maximum flow through the positive displacement pump so that the pump head of the booster pump is almost independent of the flow.

11. A system as described in claim 1, whereby the booster pump is provided with a by-pass connection.

12. A system as described in claim 11, whereby the by-pass connection is provided with a check valve.

13. A system as described in claim 12, whereby the booster pump is provided with a check valve in its discharge connection.

14. A system as described in claim 12, whereby the booster pump is provided with a check valve in its inflow connection.

15. A system as described in claim 14, whereby the check-valve in the inflow connection is opened by a pressure difference exceeding the pressure difference of the check valve in the by-pass connection at maximum flow.

16. A system as described in claim 14, whereby the check valve in the inflow connection has a closing momentum that decreases with increasing flow through the check valve.

17. A system as described in claim 16, whereby the check valve in the inflow connection is provided with a lever and weight such that the lever is about horizontal, creating a high closing momentum, while the check valve is in its closed position, and that the lever is almost vertical, creating a low closing momentum, while the check valve is in its fully open position.

18. A method for pumping high-viscous fluid having a viscosity at least five times water's viscosity through a heat exchanger, comprising the steps of:
pumping the high-viscous fluid with a variable speed positive displacement pump;
driving the fluid through a heat exchanger; and
forwarding the fluid through a booster pump.
